(19) United States
(12) Patent Application Publication
(10) Pub. No.: US 2007/0279651 A1
(43) Pub. Date: Dec. 6, 2007

(54) Printing System

(75) Inventor: Toshihiro IDA, Tokyo (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/421,725

(22) Filed: Jun. 1, 2006

(51) Int. Cl. H04N 1/60

(52) U.S. Cl. 358/1.9

(57) ABSTRACT

A printing system includes a printing pattern changing unit configured to, when a printing pattern set by a printing pattern storing unit in an identification information acquiring unit that has acquired identification information and a printing pattern of print data including the acquired identification information of print data stored in a print data storing unit are different from each other, change the printing pattern of the print data including the acquired identification information stored in the print data storing unit to the printing pattern set in the identification information acquiring unit that has acquired the identification information.

### BACKGROUND OF THE INVENTION

1. Field of the Invention

This invention relates to a printing system that changes the printing format of print data.

2. Description of the Related Art

A printing system is known in which plural personal cards storing personal information corresponding to system users are provided and plural insertion ports for personal cards are provided on a key counter, and in which one of the insertion ports is associated with the copy function of a multifunction printer and another insertion port is associated with the printer function of the printer.

In the foregoing technique, the printing pattern of print data cannot be changed after the print data is sent from a management PC (print server) to the printer. For example, in the case where print data has been outputted in the previous setting, for example, 2-in-1, despite that the user wants to print in a standard setting, the printing format of the print data cannot be changed and it is outputted in 2-in-1. Therefore, the user needs to reprint the same print data in the standard setting.

### BRIEF SUMMARY OF THE INVENTION

An object of this invention is to provide a printing system that changes the printing format of print data.

According to an aspect of this invention, a printing system includes plural identification information acquiring units configured to acquire identification information, a printing pattern storing unit configured to store a printing pattern of print data set in each of the plural identification information acquiring units, a print data storing unit configured to store print data including data indicating a printing pattern, and a printing pattern changing unit configured to, when the printing pattern set by the printing pattern storing unit in the identification information acquiring unit that has acquired identification information and the printing pattern of print data including the acquired identification information of the print data stored in the print data storing unit are different from each other, change the printing pattern of the print data including the acquired identification information stored in the print data storing unit to the printing pattern set in the identification information acquiring unit that has acquired the identification information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view schematically showing a network configuration in an embodiment of this invention.

FIG. 2 is a view functionally showing the construction of essential parts of an image forming apparatus in the same embodiment.

FIG. 3 is a table in which card readers and printing patterns are associated with each other in the same embodiment.

FIG. 4 is a view showing an exemplary screen for setting a printing pattern in the same embodiment.

FIG. 5 is a flowchart showing essential parts of printing pattern changing processing in the same embodiment.

FIG. 6 is a view showing an exemplary display of a print data list in the same embodiment.

FIG. 7 is a table in which time and printing patterns are associated with each other in a modification of the same embodiment.

### DETAILED DESCRIPTION OF THE INVENTION

Hereinafter, an embodiment of this invention will be described with reference to the drawings.

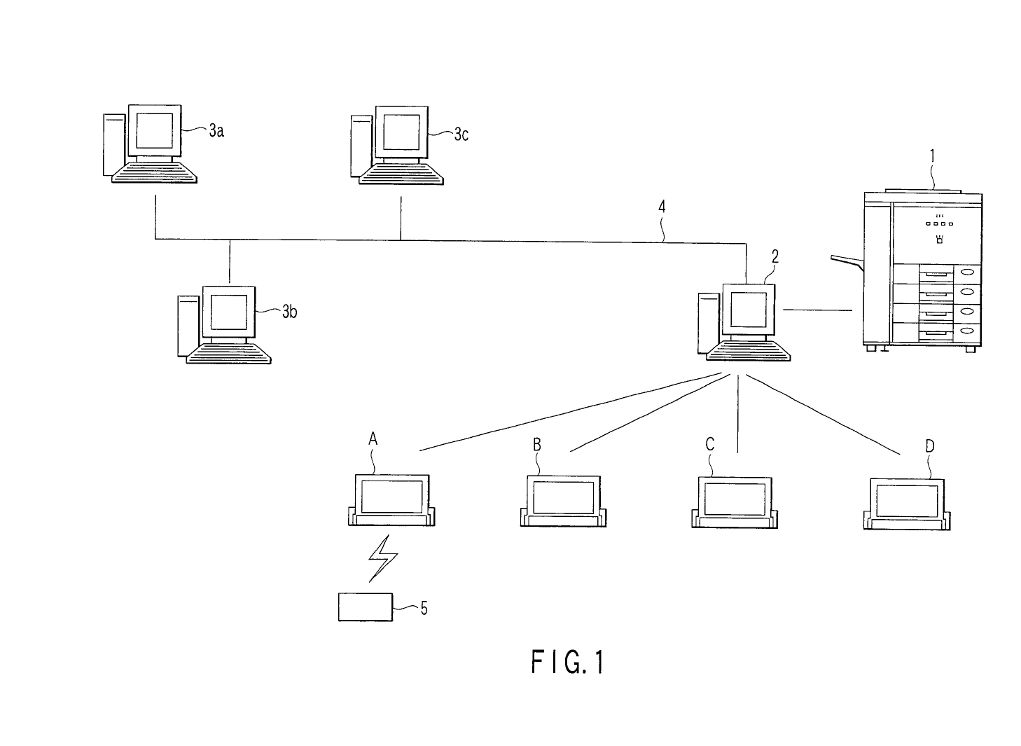

FIG. I is a view schematically showing a network configuration. As shown in FIG. 1, a multifunction peripheral (MFP) 1, a management PC 2, and plural terminal devices 3a, 3b, 3c are connected to a network via a network 4. Also, plural card readers A, B, C, D are connected to the management PC 2. From a card 5 storing identification information (hereinafter referred to as code) that identifies an individual or group, the card readers A, B, C, D can acquire the code in a non-contact manner.

The management PC 2 stores print data sent from the respective terminal devices 3a, 3b, 3c. The code acquired from the card 5 has been added to this print data. This code is used for specifying the sender. The management PC 2 may have a table in which an address on the network 4 and the code is associated with each other, and by using this table, the management PC 2 may specify the code from the address on the network sent from the respective terminal devices 3a, 3b, 3c.

In the following, a case where private print is designated for the print data sent from the respective terminal devices 3a, 3b, 3c will be described. Therefore, the print data will not be printed unless an instruction from the user (in this embodiment, recognition of the code by the card reader) is given.

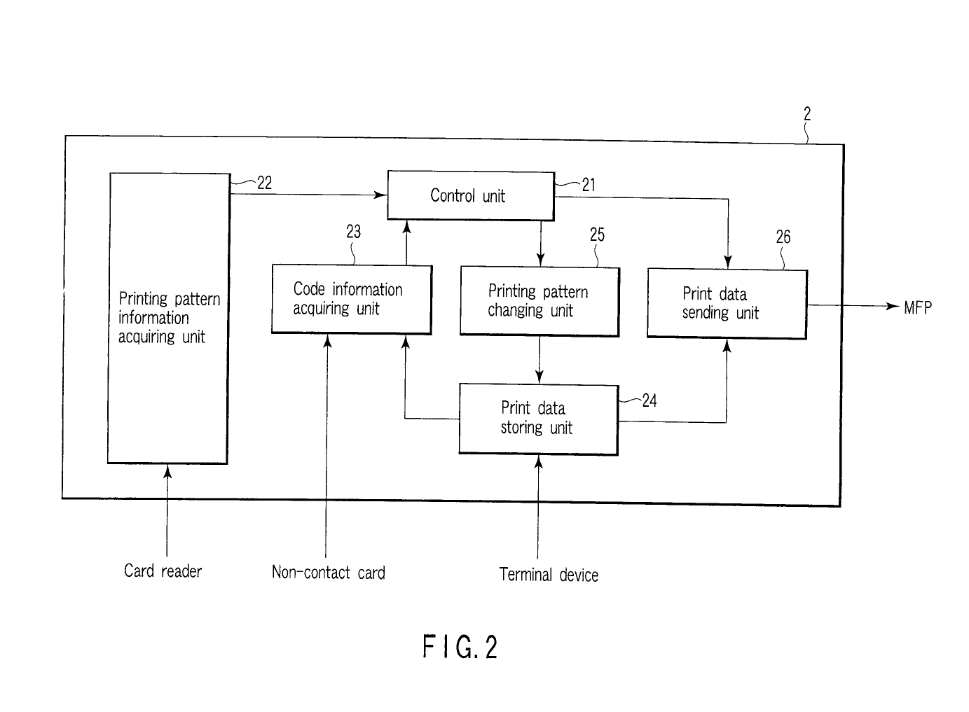

FIG. 2 is a view functionally showing the construction of essential parts of the MFP 1. The MFP 1 has a control unit 21, a printing pattern information acquiring unit 22, a code information acquiring unit 23, a print data storing unit 24, a printing pattern changing unit 25, and a print data sending unit 26. The functions executed by these control unit 21, printing pattern information acquiring unit 22, code information acquiring unit 23, print data storing unit 24, printing pattern changing unit 25 and print data sending unit 26 are realized by a CPU, ROM, RAM, hard disk driver (HDD) and the like.

The control unit 21 collectively controls the printing pattern information acquiring unit 22, code information acquiring unit 23, printing pattern changing unit 25 and print data sending unit 26.

When one of the card readers A, B, C, D has acquired a code from the card 5 in a non-contact manner, the printing pattern information acquiring unit 22 acquired card reader information indicating the card reader that has acquired the code. Then, the printing pattern information acquiring unit 22 acquires the setting of the printing pattern of the card reader indicated by this acquired information.

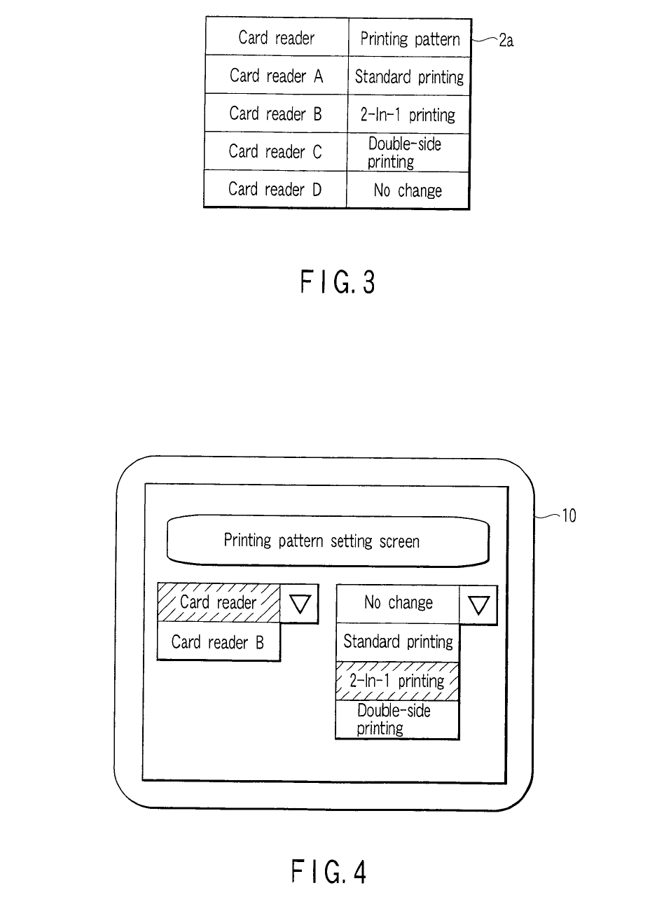

FIG. 3 is a table 2a in which the card readers A, B, C, D and settings of printing patterns are associated with each other. This table 2a is saved in the management PC 2. As shown in FIG. 3, printing patterns are set corresponding to the card readers A, B, C, D. Specifically, standard printing for the card reader A, 2-IN-1 printing for the card reader B, double-side printing for the card reader C, and no change for the card reader D are set. FIG. 4 is a view showing a setting screen 10 for the printing pattern for each of the card readers A, B, C, D in the management PC 2. With this setting screen 10, the printing pattern for each of the card readers A, B, C, D is set by the user.

Therefore, for example, when the card reader information indicating the card reader A is acquired the printing pattern information acquiring unit 22 acquires the information that the printing pattern is standard printing. The printing pattern acquiring unit 22 gives information indicating the acquired printing pattern to the control unit 21.

The code information acquiring unit 23 acquires a code from one of the card readers A, B, C, D. The card information acquiring unit 23 also gives information about whether there is print data including the acquired code in the print data stored in the print data storing unit 24, to the control unit 21. When there is print data including the acquired code, the code information acquiring unit 22 also gives information indicating the print data to the control unit 21.

The print data storing unit 24 stores print data including codes sent from the respective terminal devices 3a, 3b, 3c. Information indicating the printing pattern has been added to, for example, the header part of the print data thus sent from the respective terminal devices 3a, 3b, 3c.

The printing pattern changing unit 25 changes the printing pattern of the print data stored in the print data storing unit 24 corresponding to the list of print data given by the control unit 21, to the printing pattern given by the control unit 21. In this embodiment, processing to change the printing pattern for each print data is carried out, as will be described later. If the printing patterns are the same, the processing to change the print pattern will not be carried out.

The print data sending unit 26 reads out the print data corresponding to the print data given by the control unit 21, from the print data storing unit 24, and sends it to the MFP 1.

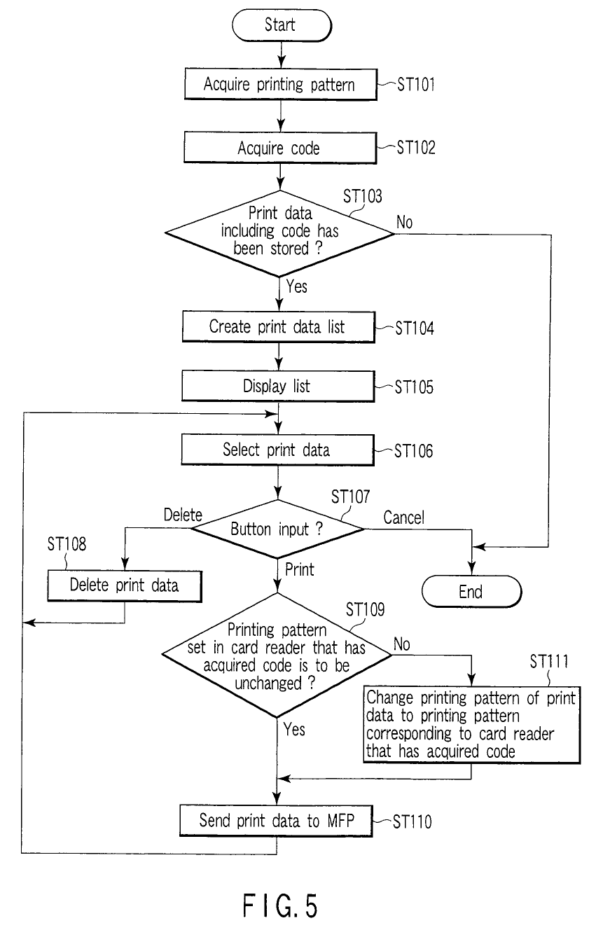

FIG. 5 is a flowchart showing essential parts of the printing pattern changing processing executed by the control unit 21.

First, the control unit 21 acquires a printing pattern set in a card reader that has recognized a code (ST101), and then acquires information indicating the code (ST102). As these items of information are acquired, the control unit 21 judges whether print data including the code has been stored or not (ST103). If it is judged that print data including the code has not been stored (NO at ST103), the control unit 21 ends the processing.

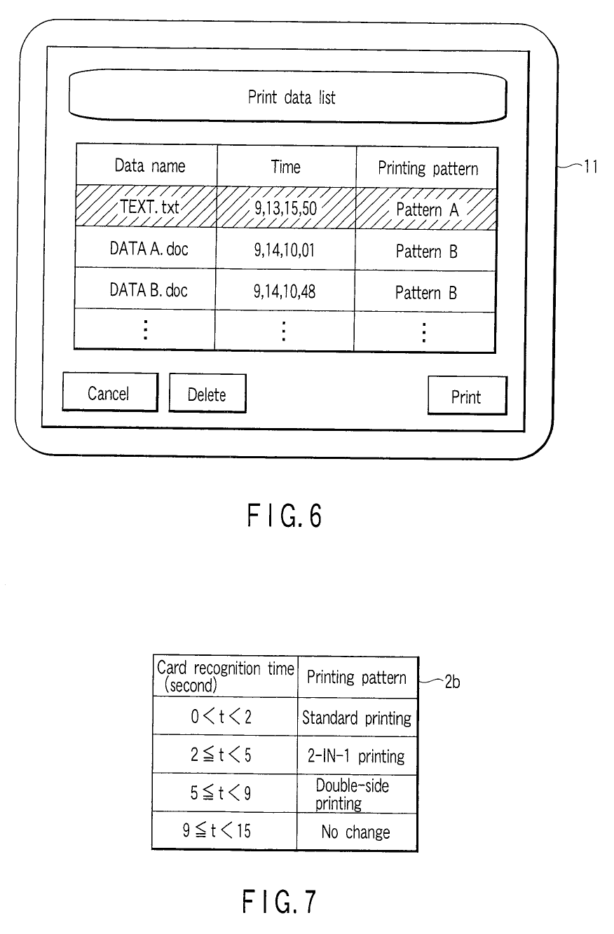

On the other hand, if it is judged that print data including the code has been stored (YES at ST103), the control unit 21 creates a list of print data based on a print data list (ST104). When the creation of the list is finished, the control unit 21 displays the created list on a display unit such as a monitor (ST105). FIG. 6 is a view showing a display screen 11 of a print data list. As shown in FIG. 6, the list of the print data including the code recognized by the card reader is displayed. In this list, data name, time (time when print data is accepted) and printing pattern of print data are displayed. Also, “cancel”, “delete” and “print” are displayed as input buttons near this print data list.

Next, the control unit 21 selects print data displayed in the list (ST106). This selection is carried out, for example, by the user's operation of a keyboard or the like, not shown. Then, the control unit 21 makes judgment about button input (ST107). If the control unit 21 judges that the button input is “cancel” in the judgment at step ST107, the control unit 21 ends the processing. If the control unit 21 judges that the button input is “delete” in the judgment at step ST107, the control unit 21 deletes the selected print data (ST108). Thus, the selected print data is deleted from the management PC 2.

If the control unit 21 judges that the button input is “print” in the judgment at step ST107, the control unit judges whether the printing pattern is to be changed or not (ST109). That is, it is judged whether the printing pattern set in the card reader that has acquired the code and the printing pattern of the print data are coincide with each other or not.

If the control unit 21 judges that the printing pattern is not to be changed, that is, the printing pattern set in the card reader that has acquired the code and the printing pattern of the print data are coincident with each other (YES at ST108), the control unit 21 sends the print data to the MFP 1 without changing the printing pattern (ST110).

On the other hand, if the control unit 21 judges that the printing pattern is to be changed, that is, the printing pattern set in the card reader that has acquired the code and the printing pattern of the print data are not coincide with each other (NO at ST109), the control unit 21 changes the printing pattern of the print data to the printing pattern corresponding to the card reader that has acquired the code (ST111). Then, the control unit 21 sends the print data with the changed printing pattern to the MFP 1 (ST110).

According to this embodiment, when the user wants to change the printing pattern of print data sent to the management PC 2, the user first holds the card on which the user's code has been stored, over the card reader in which the target printing pattern has been set. Then, the user selects the print data for which the user wants to change the printing pattern, from the displayed list, and inputs “print”. Thus, the user can change the printing pattern. That is, the user need not retransmit the print data from the terminal device after changing the printing pattern.

In the above embodiment, the print data list is displayed and printing jobs are sent one by one. However, this processing may be omitted, and all the print data including the code acquired by the card reader may be automatically sent to the MFP 1 in the printing pattern corresponding to the card reader.

In the above embodiment, the case of setting the printing patterns corresponding to the card readers A, B, C, D as shown in FIG. 3. However, using a single card reader, the printing pattern may be changed by utilizing the time to recognize the card by the card reader.

FIG. 7 is a table in which time and printing patterns are associated with each other. By using the table in which a printing pattern is set corresponding to the time taken by one card reader for authenticating a code stored on a card, as shown in this FIG. 7, similar effects to those of the above embodiment can be provided. As a beep sound is generated every time the printing pattern is changed, the user can be notified of how much time has passed. Also, the printing pattern may be displayed on the display unit of the management PC 2. The user can learn what printing pattern the printing pattern for change is, from the number of times of this sound or the display of the printing pattern.

Also, though the case where the printing system includes the management PC 2 having plural card readers and the MFP 1 is described in the above embodiment, the invention is not limited to this. That is, the functions described with respect to the management PC 2 may be included in the MFP 1.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A printing system comprising:
plural identification information acquiring units configured to acquire identification information;
a printing pattern storing unit configured to store a printing pattern of print data set in each of the plural identification information acquiring units;
a print data storing unit configured to store print data including data indicating a printing pattern; and
a printing pattern changing unit constructed to, when the printing pattern set by the printing pattern storing unit in the identification information acquiring unit that has acquired identification information and the printing pattern of print data including the acquired identification information of the print data stored in the print data storing unit are different from each other, change the printing pattern of the print data including the acquired identification information stored in the print data storing unit to the printing pattern set in the identification information acquiring unit that has acquired the identification information.

2. The printing system according to claim 1, further comprising a control unit configured to display a list of print data including the acquired identification information.

3. The printing system according to claim 2, further comprising a selecting unit constructed to select print data from the list of print data,
wherein the printing pattern changing unit changes only the printing pattern of the print data selected by the selecting unit.

4. The printing system according to claim 3, wherein change of the printing pattern by the printing pattern changing unit is executed after input of a button provided near the list is detected.

5. The printing system according to claim 1, wherein the plural identification information acquiring units are plural card readers.

6. The printing system according to claim 5, wherein the card reader acquires identification information in a non-contact manner from a card on which the identification information is stored.

7. The printing system according to claim 1, wherein the print data is data for performing private printing.

8. A printing system comprising:
plural identification information acquiring means for acquiring identification information;
printing pattern storing means for storing a printing pattern of print data set in each of the plural identification information acquiring means;
print data storing means for storing print data including data indicating a printing pattern; and
printing pattern changing means for, when the printing pattern set by the printing pattern storing means in the identification information acquiring means that have acquired identification information and the printing pattern of print data including the acquired identification information of the print data stored in the print data storing means are different from each other, changing the printing pattern of the print data including the acquired identification information stored in the print data storing means to the printing pattern set in the identification information acquiring means that has acquired the identification information.

9. The printing system according to claim 8, further comprising control means for displaying a list of print data including the acquired identification information.

10. The printing system according to claim 9, further comprising selecting means for selecting print data from the list of print data,
wherein the printing pattern changing means changes only the printing pattern of the print data selected by the selecting means.

11. The printing system according to claim 10, wherein change of the printing pattern by the printing pattern changing means is executed after input of a button provided near the displayed list is detected.

12. The printing system according to claim 8, wherein the plural identification information acquiring means are plural card readers,

13. The printing system according to claim 12, wherein the card reader acquires identification information in a non-contact manner from a card on which the identification information is stored.

14. The printing system according to claim 8, wherein the print data is data for performing private printing.

15. A printing pattern changing method for print data in a printing system, comprising:
acquiring identification information from one of plural identification information acquiring units;
acquiring a printing pattern set in the identification information acquiring unit that has acquired the identification information; and
when this acquired printing pattern is different from a printing pattern of print data including the acquired identification information of stored print data, changing the printing pattern of the print data including the acquired identification information to the printing pattern set in the identification information acquiring unit.

16. The method according to claim 15, further comprising the step of displaying a list of print data including the acquired identification information.

17. The method according to claim 16, further comprising the step of selecting print data from the list of print data,
wherein the step of changing the printing pattern includes changing only the printing pattern of the selected print data.

18. The method according to claim 17, wherein the change of the printing pattern is executed after input of a button provided near the displayed list is detected.

19. The method according to claim 15, wherein the plural identification information acquiring units are plural card readers.

20. The method according to claim 19, wherein the card reader acquires identification information in a non-contact manner from a card on which the identification information is stored.
